(19) United States
(12) Patent Application Publication
(10) Pub. No.: US 2025/0370629 A1
(43) Pub. Date: Dec. 4, 2025

(54) Video Data Management Based on Data Storage Device Terabytes Written

(71) Applicant: SanDisk Technologies LLC, San Jose, CA (US)

(72) Inventors: Akhilesh Yadav, Bangalore (IN); Ramanathan Muthiah, Bangalore (IN)

(21) Appl. No.: 18/677,111

(22) Filed: May 29, 2024

(51) Int. Cl. G06F 3/06

(52) U.S. Cl. CPC G06F 3/0616; G06F 3/0635; G06F 3/0688

(57) ABSTRACT

Systems, methods, and data storage devices for video data management based on data storage device lifetime endurances, such as terabytes written (TBW) ratings, are described. A data routing controller is integrated with a video camera that supports at least two non-volatile memory devices having different lifetime endurance ratings, such as SLC and QLC flash devices. The data routing controller determines lifetime endurance values for the different non-volatile memory devices and selects the device with the higher lifetime endurance value to act as an intermediate device to store real-time video data units, then subsequently evaluates the stored video data units prior to invalidation to selectively transfer to other non-volatile memory devices with lower lifetime endurance values (but higher capacity) based on detected video events.

### TECHNICAL FIELD

The present disclosure relates to data storage management, and more particularly to a system and method for managing video data storage based on terabytes written (TBW) values of storage devices.

### BACKGROUND

In the field of digital storage devices, such as Solid State Drives (SSDs) and Secure Digital (SD) cards, data is stored in memory cells. These memory cells can be of different flash memory types, including Single-Level Cell (SLC), Multi-Level Cell (MLC), Triple-Level Cell (TLC), and Quad-Level Cell (QLC). Each type of cell has its own characteristics and capabilities.

SLC memory cells store one bit of data per cell. They are known for their high endurance and low power consumption, but they also have higher manufacturing costs and lower densities compared to other types of cells. On the other hand, MLC, TLC, and QLC memory cells can store multiple bits of data per cell. MLC stores two bits, TLC stores three bits, and QLC stores four bits of data per cell. These types of cells can store more data in a similar sized device compared to SLC, making them more cost-effective in terms of storage capacity. However, they have lower endurance compared to SLC due to the higher number of bits stored per cell.

The endurance of a storage device is often measured in terms of terabytes written (TBW), which represents the total amount of data that can be written to the device before it wears out. The TBW capability of a device is influenced by the type of memory cells it uses. For instance, SLC-based devices typically have a higher TBW capability compared to TLC-based devices.

In video surveillance applications, such as dash-cams, the data captured and stored is often temporary and frequently recycled. This high frequency of data recycling can lead to a rapid wear-out of the storage device, limiting its lifespan. The storage capacity of a device also plays a role in its lifespan. For instance, a device with a capacity of 1 terabyte (TB) can record a limited number of hours of high-definition video before it fills up. Once filled, the device has to recycle its memory cells to make room for new data, which contributes to the wear-out of the device.

There is a need for video storage systems that use storage devices with different TBW ratings to store video surveillance data with improved lifecycle management for the storage devices.

### SUMMARY

Various aspects for using TBW ratings to manage video storage to multiple storage devices, particularly use of devices with high TBW ratings as intermediate storage devices, are described.

One general aspect includes a system that includes: at least one processor; at least one memory; at least one storage device interface configured for communication with a first data storage device configured to store video data, where the first data storage device has a first lifetime endurance rating, and a second data storage device configured to store video data, where the second data storage device has a second lifetime endurance rating; a video capture interface configured to receive video data from a video sensor; and at least one data routing controller.

The data routing controller is configured to, alone or in combination: receive a video data unit from the video capture interface; determine a first lifetime endurance value for the first data storage device; determine a second lifetime endurance value for the second data storage device; determine, based on a comparison of the first lifetime endurance value and the second lifetime endurance value determining that the first data storage device has a greater lifetime endurance value, a first storage location in the first data storage device for the video data unit; and store the video data unit to the first storage location.

Implementations may include one or more of the following features. The first lifetime endurance rating may be based on a first flash memory type; the second lifetime endurance rating may be based on a second flash memory type; the first flash memory type and the second flash memory type may be selected from: NAND cells having one bit per cell, NAND cells having two bits per cell, NAND cells having three bits per cell, NAND cells having four bits per cell, and NAND cells having at least five bits per cell; and the first flash memory type may be different than the second flash memory type. The data routing controller may by further configured to: determine, for the video data unit, an invalidation prediction value; determine, for the video data unit, that the invalidation prediction value meets a transfer threshold value; write the video data unit from the first storage location to a second storage location in the second data storage device; and invalidate the video data unit in the first storage location. The data routing controller may be further configured to: monitor a data retention cycle for captured video data; and determine, based on the data retention cycle, that the video data unit in the first storage location is due for invalidation. Determining that the invalidation prediction value meets the transfer threshold value may be responsive to determining that the video data unit in the first storage location is due for invalidation. The data retention cycle may be based on a configurable fill threshold of the first data storage device. The system may further include at least one event detector, stored in the at least one memory for execution by the at least one processor operating alone or in combination, configured to analyze the video data unit to determine whether the video data unit includes at least one video event of interest. The data routing controller may be further configured to determine the invalidation prediction value responsive to and based on the at least one video event of interest. The at least one event detector may be further configured to determine: at least one video event type of the at least one video event of interest in the video data unit; and at least one confidence value for the at least one video event of interest. The invalidation prediction value for the video data unit may be based on the at least one video event type and the at least one confidence value for the at least one video event of interest meeting a confidence threshold. The at least one event detector may be further configured to read the video data unit from the first storage location to analyze the video data unit. The system may further include a video camera that includes: the video sensor; the at least one processor; the at least one memory; the at least one storage device interface, where the at least one storage device interface may include at least two memory card slots configured to receive the first data storage device and the second data storage device; the video capture interface; and the data routing controller. The system may further include the first data storage device and a plurality of secondary data storage devices. The first data storage device may include: the at least one processor; the at least one memory; the data routing controller; and a host interface configured to receive the video data from a host system. The at least one storage device interface may include a storage interface bus connecting the first data storage device and the second data storage device and the first data storage device may be configured as bridge device between the host system and a plurality of secondary data storage devices. Each data storage device of the plurality of secondary data storage devices may include a controller memory buffer configured for direct memory access by the first data storage device and have a lifetime endurance rating that is different from the first lifetime endurance rating of the first data storage device; and the plurality of secondary data storage devices includes the second data storage device.

Another general aspect includes a computer-implemented method that includes: receiving a video data unit generated by a video sensor; determining a first lifetime endurance value for a first data storage device configured to store video data, where the first data storage device has a first lifetime endurance rating; determining a second lifetime endurance value for a second data storage device configured to store video data, where the second data storage device has a second lifetime endurance rating; determining, based on a comparison of the first lifetime endurance value and the second lifetime endurance value determining that the first data storage device has a greater lifetime endurance value, a first storage location in the first data storage device for the video data unit; and storing the video data unit to the first storage location.

Implementations may include one or more of the following features. The first lifetime endurance rating may be based on a first flash memory type; the second lifetime endurance rating may be based on a second flash memory type; the first flash memory type and the second flash memory type may be selected from: NAND cells having one bit per cell, NAND cells having two bits per cell, NAND cells having three bits per cell, NAND cells having four bits per cell, and NAND cells having at least five bits per cell; and the first flash memory type may be different than the second flash memory type. The computer-implemented method may include: determining, for the video data unit, an invalidation prediction value; determining, for the video data unit, that the invalidation prediction value meets a transfer threshold value; writing the video data unit from the first storage location to a second storage location in the second data storage device; and invalidating the video data unit in the first storage location. The computer-implemented method may include: monitoring a data retention cycle for captured video data; and determining, based on the data retention cycle, that the video data unit in the first storage location is due for invalidation, where determining that the invalidation prediction value meets the transfer threshold value is responsive to determining that the video data unit in the first storage location is due for invalidation. The data retention cycle may be based on a configurable fill threshold of the first data storage device. The computer-implemented method may include: analyzing the video data unit to determine whether the video data unit includes at least one video event of interest; and determining the invalidation prediction value responsive to and based on the at least one video event of interest. The computer-implemented method may include: determining at least one video event type of the at least one video event of interest in the video data unit; and determining at least one confidence value for the at least one video event of interest, where the invalidation prediction value for the video data unit is based on the at least one video event type and the at least one confidence value for the at least one video event of interest meeting a confidence threshold. The computer-implemented method may include reading the video data unit from the first storage location to analyze the video data unit. The computer-implemented method may include: receiving, by the first data storage device and from a host system, the video data unit; storing, by the first data storage device, the video data unit to the first storage location; selecting the second data storage device from a plurality of secondary data storage devices in communication with the first data storage device, where each data storage device of the plurality of secondary data storage devices has a lifetime endurance rating that is different from the first lifetime endurance rating of the first data storage device; writing, using direct memory access, the video data unit to a controller memory buffer of the second data storage device; and invalidating the video data unit in the first storage location.

Still another general aspect includes a video camera that includes: a video sensor; at least one processor; at least one memory; at least one storage device interface, where the at least one storage device interface may include means to receive a first data storage device configured to store video data, where the first data storage device has a first lifetime endurance rating, and a second data storage device configured to store video data, where the second data storage device has a second lifetime endurance rating; means for generating a video data unit from the video sensor; means for determining a first lifetime endurance value for the first data storage device; means for determining a second lifetime endurance value for the second data storage device; means for determining, based on a comparison of the first lifetime endurance value and the second lifetime endurance value determining that the first data storage device has a greater lifetime endurance value, a first storage location in the first data storage device for the video data unit; and means for storing the video data unit to the first storage location.

The various embodiments advantageously apply the teachings of data storage devices and/or video storage systems to improve the functionality of such computer systems, particular storage systems integrated with surveillance camera systems. The various embodiments include operations to overcome or at least reduce the issues previously encountered in video storage systems and, accordingly, are more efficient, reliable, and/or cost-effective than other computing systems configured for video storage integrated with surveillance video cameras. That is, the various embodiments disclosed herein include hardware and/or software with functionality to improve lifecycle management of multiple data storage devices in a camera system, such as by using device TBW to select intermediate storage and determine when video data should be moved to lower TBW devices. Accordingly, the embodiments disclosed herein provide various improvements to video surveillance cameras and integrated storage systems.

It should be understood that language used in the present disclosure has been principally selected for readability and instructional purposes, and not to limit the scope of the subject matter disclosed herein.

### BRIEF DESCRIPTION OF THE DRAWINGS

FIG. 1 schematically illustrates a camera storage system with a host system, data routing controller, and multiple storage devices.

FIG. 2 is a flowchart of an example method for managing video data storage based on TBW values.

FIGS. 3 and 4 schematically illustrate a camera storage system and a storage system, respectively, each with a master controller managing data across multiple memory cards or storage devices using TBW values.

FIG. 5 schematically illustrates a storage system with a processor, memory, video manager, object detector, and data routing engine using TBW values.

FIG. 6 is a flowchart of an example method for managing video data storage based on TBW values.

FIG. 7 is a flowchart of another example method for managing video data storage based on TBW values.

### DETAILED DESCRIPTION

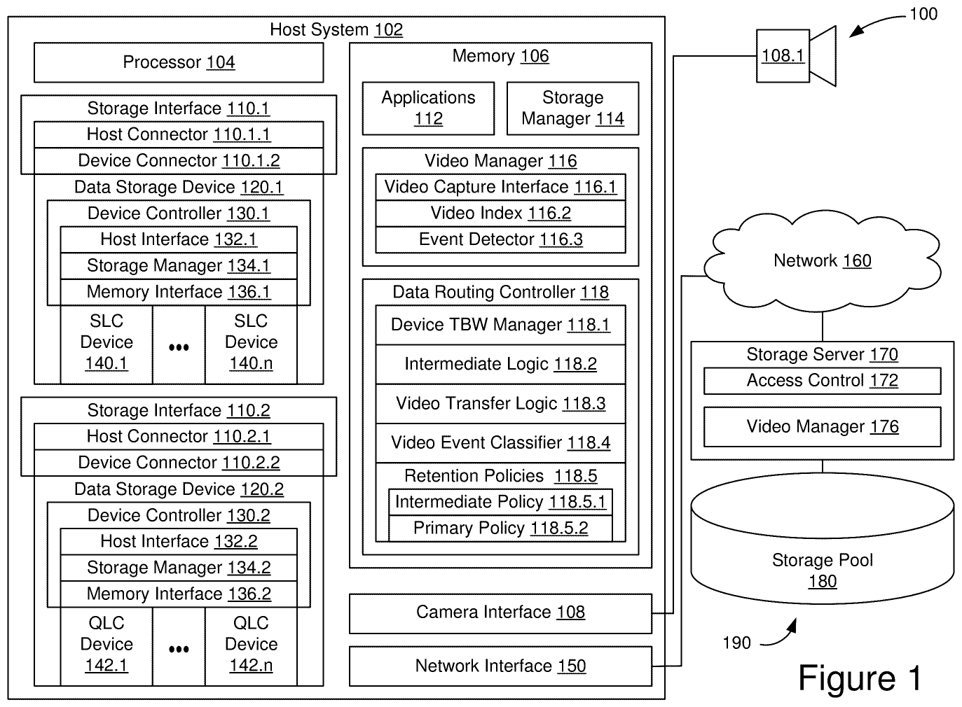

FIG. 1 shows an embodiment of an example camera storage system 100 with host device 102 hosting multiple data storage devices 120 configured to store video data and move the video data among data storage devices 120 based on TBW values and video events. In some embodiments, host device 102 may interface or communicate with a storage server 170, such as a cloud video storage or remote surveillance video management system, over network 160. Host device 102 and/or data storage devices 120 may connect to network 160 to communicate with network storage system 190 that includes storage server 170 and storage pool 180. While some example features are illustrated, various other features have not been illustrated for the sake of brevity and so as not to obscure pertinent aspects of the example embodiments disclosed herein. To that end, as a non-limiting example, data storage system 100 includes two or more data storage devices 120 (also sometimes called information storage devices, disk drives, or drives) in communication with host device 102 and having different TBW characteristics that may include a TBW rating for the predicted endurance of the device and operating TBW value for the data written to the device so far. In some embodiments, host device 102 may be an end user device with an embedded computing system, such as a video camera, surveillance system, mobile phone, tablet computer, smart television, smart appliance, portable game device, other consumer electronic device, or an integrated video system for an automobile or other vehicle. In some embodiments, storage devices 120 may be removable storage devices, such as a universal serial bus (USB) flash drive, secure digital (SD) card, extended capacity (SDXC) SD card, or other removable storage devices.

In the embodiment shown, storage devices 120.1 and 120.2 are attached to respective storage interfaces 110.1 and 110.2 for host communication with host device 102. For example, host device 102 may include host connectors 110.1.1 and 110.2.1, such as a peripheral component interface express (PCIe) connector, USB slot, memory card slot/reader (for Memory Stick, MultiMedia Card, SD, SDXC, etc. memory cards), etc., that provides a physical connector configured to mate with a corresponding storage device connectors 110.1.2 and 110.2.2. In some embodiments, host connectors 110.1.1 and 110.2.1 may define a slot or port providing a wired internal connection to a host bus or storage interface controller. In some embodiments, device connectors 110.1.2 and 110.2.2 may include a portion of a storage device housing or projection therefrom that removably inserts into the slot or port in host connectors 110.1.1 and 110.2.1 to provide a physical attachment and electrical connection for host-device communication. In some embodiments, an intervening wire, extender, switch, or similar device compatible with host connectors 110.1.1 and 110.2.1 and device connectors 110.1.2 and 110.2.2 may be inserted between the respective host connectors and device connectors without materially changing the host-device interface or operation of storage interfaces 110.

In some embodiments, storage interfaces 110 may be configured to use network communication protocols. Host connectors and device connectors may include any type of physical connector compatible with one or more network and/or internet protocols. For example, host connectors and device connectors may include ethernet, PCIe, Fibre Channel, small computer serial interface (SCSI), serial attached SCSI (SAS), or another network-capable interface. Storage interfaces 110 may include or interconnect with a plurality of physical port connections and intermediate components that define physical, transport, and other logical channels for establishing communication with the different components and subcomponents for establishing a communication channel between host device 102 and storage devices 120. In some embodiments, storage interfaces 110 may provide a primary host interface for storage device management and host data transfer, as well as a control interface that includes limited connectivity to the host for low-level control functions, such as through a baseboard management controller (BMC).

In some embodiments, data storage devices 120 are, or include, a solid-state memory device. Data storage devices 120 may include a non-volatile memory (NVM) or storage device controllers 130 based on compute resources (processor and memory) and a plurality of NVM or media devices for data storage (e.g., one or more NVM device(s), such as SLC, MLC, TLC, or QLC flash devices. In the example shown, storage device 120.1 includes SLC devices 140.1-140.n and storage device 120.2 includes QLC devices 142.1-142.n. In some embodiments, storage device controllers 130 may include a host interface controller 132, a host storage manager 134, and one or more memory interface controllers 136. For example, host interface controllers 132 may include a physical subsystem, such as an application specific integrated circuit (ASIC) or system on a chip (SOC), and/or logic or firmware running on the general compute resources of storage device controllers 130 for configuring and controlling communication with host device 102 over storage interfaces 110. Host storage manager 134 may include configuration, background, and storage processing operations running on the general compute resources of storage device controllers 130 to coordinate operation of storage devices 120, host interface controllers 132, and memory interface controllers 136. Memory interface controllers 136 may include a physical memory bus and related resources for connecting to media devices 140.1-140.n and 142.1-142.n, such as flash controllers or channel controllers (e.g., for storage devices having NVM devices in multiple memory channels). In some embodiments, data storage devices 120 may each be packaged in a housing, such as a multi-part sealed housing with a defined form factor and ports and/or connectors, such as device connectors 110.1.2 and 110.2.2, for interconnecting with respective storage interfaces 110.1 and 110.2.

In some embodiments, each data storage device 120 may include a single medium device while in other embodiments each data storage device 120 includes a plurality of media devices. In some embodiments, media devices 140 and 142 may include NAND-type flash memory or NOR-type flash memory. In some embodiments, data storage devices 120 may include one or more hard disk drives (HDDs). In some embodiments, data storage devices 120 may include a flash memory device, which in turn includes one or more flash memory die, one or more flash memory packages, one or more flash memory channels, or the like. However, in some embodiments, data storage devices 120 may have other types of non-volatile data storage media (e.g., phase-change random access memory (PCRAM), resistive random access memory (ReRAM), spin-transfer torque random access memory (STT-RAM), magneto-resistive random access memory (MRAM), etc.). Regardless of storage device type, each storage device may have an associated TBW rating that determines the total number of page write operations the device is predicted to be able to handle over its lifetime based on defined use conditions (generally based on testing and modelling a population of devices with similar characteristics).

In some embodiments, storage devices 120 include storage device controller 130, which includes one or more processing units (also sometimes called central processing units (CPUs), processors, microprocessors, or microcontrollers) configured to execute instructions in one or more programs. In some embodiments, the one or more processors are shared by one or more components within, and in some cases, beyond the function of the device controller. Media devices may be coupled to device controllers 130 through connections that typically convey commands in addition to data, and optionally convey metadata, error correction information and/or other information in addition to data values to be stored in media devices and data values read from the media devices. Media devices may include any number (i.e., one or more) of memory devices including, without limitation, non-volatile semiconductor memory devices, such as flash memory device(s).

In some embodiments, media devices in storage devices 120 are divided into a number of addressable and individually selectable blocks, sometimes called erase blocks. In some embodiments, individually selectable blocks are the minimum size erasable units in a flash memory device. In other words, each block contains the minimum number of memory cells that can be erased simultaneously (i.e., in a single erase operation). Each block is usually further divided into a plurality of pages and/or word lines, where each page or word line is typically an instance of the smallest individually accessible (readable) portion in a block. In some embodiments (e.g., using some types of flash memory), the smallest individually accessible unit of a data set, however, is a sector or codeword, which is a subunit of a page. That is, a block includes a plurality of pages, each page contains a plurality of sectors or codewords, and each sector or codeword is the minimum unit of data for reading data from the flash memory device.

A data unit may describe any size allocation of data, such as host block, data object, sector, page, multi-plane page, erase/programming block, media device/package, etc. Storage locations may include physical and/or logical locations on storage devices 120 and may be described and/or allocated at different levels of granularity depending on the storage medium, storage device/system configuration, and/or context. For example, storage locations may be allocated at a host logical block address (LBA) data unit size and addressability for host read/write purposes but managed as pages with storage device addressing managed in the media flash translation layer (FTL) in other contexts. Media segments may include physical storage locations in storage devices 120, which may also correspond to one or more logical storage locations. In some embodiments, media segments may include a continuous series of physical storage location, such as adjacent data units on a storage medium, and, for flash memory devices, may correspond to one or more media erase or programming blocks. A logical data group may include a plurality of logical data units that may be grouped on a logical basis, regardless of storage location, such as data objects, files, or other logical data constructs composed of multiple host blocks. In some configurations, logical and/or physical zones may be assigned within storage devices 120 as groups of data blocks allocated for specified host data management purposes. Video data objects may include any standardized data structure for organizing and storing a time-based series digital images or video frames in raw, compressed, or vector formats. For example, video data objects may include video data formatted and stored in accordance with one or more video formats, such as Motion Picture Experts Group (MPEG)-4, Windows media video (WMV), QuickTime file format (.MOV), audio video interleave (AVI), and other video format files.

In some embodiments, host, host system, or host device 102 may be coupled to network 160 through a network interface 150. In some embodiments, network 160 may operate over a wired and/or wireless network (e.g., public and/or private computer networks in any number and/or configuration) which may be coupled in a suitable way for transferring data. For example, network 160 may include any means of a conventional data communication network such as a local area network (LAN), a wide area network (WAN), a telephone network, such as the public switched telephone network (PSTN), an intranet, the internet, or any other suitable communication network or combination of communication networks.

Host device 102 may be any suitable end-user computer device, such as a surveillance video system or another computer or consumer electronics device integrated or interfacing with a camera 108.1 via a camera interface 108. In some configurations, camera interface 108 may include a bus or interface connection to camera 108.1. For example, camera 108.1 may be an integrated camera that communicates with other components of host system 102 using a peripheral component interface express (PCIe), universal serial bus (USB), or similar data bus connection. In some configurations, camera interface 108 may support a wired or wireless connection to camera 108.1 that is physically separated from host system 102. For example, camera 108.1 may include a dash camera, body camera, or other surveillance camera positioned proximate to and in communication with host system 102 for capture and storage of video data. While only a single camera 108.1 is shown, host system 102 and camera interface 108 may support multiple cameras for video capture and storage.

Host device 102 may include one or more central processing units (CPUs) or processors 104 for executing compute operations or instructions for accessing storage devices 120 through storage interfaces 110. Processor 104 may include multiple processors or processor cores that operate alone or in combination to execute various threaded or distributed compute operations to carry out the functions described. In some embodiments, processor 104 may be associated with operating memory 106 for executing both storage operations and a storage interface protocol compatible with storage interfaces 110 and storage devices 120. In some embodiments, a separate storage interface unit (not shown) may provide the storage interface protocol and related processor and memory resources. From the perspective of storage device 120, storage interface 110 may be referred to as a host interface and provides a host data path between storage device 120 and host device 102.

Host device 102 may include memory 106 configured to support various data access and management functions, generally in support of one or more applications 112. Memory 106 may include a random access memory (RAM) or another type of dynamic storage device that stores information and instructions for execution by processor 104 and/or a read only memory (ROM) or another type of static storage device that stores static information and instructions for use by processor 104 and/or any suitable storage element such as a hard disk or a solid state storage element. For example, memory 106 may include one or more dynamic random access memory (DRAM) devices for use by host device 102 for command, management parameter, and/or host data storage and transfer to and from storage devices 120.

In some embodiments, host device 102 may include one or more applications 112 instantiated in user device memory 106 for execution by user device processor 104. Applications 112 may include and/or be configured to access one or more storage management functions of storage manager 114. Storage manager 114 may include applications, services, libraries, and/or corresponding interfaces for managing the contents and operation of storage devices 120 on behalf of host device 102. For example, storage manager 114 may include services for monitoring storage device parameters, such as TBW rating, TBW operating values, total capacity, capacity used, and capacity available, tracking storage device input/output (I/O) history, performance, and workload, and initiating host storage maintenance functions, such as media scans, defragmentation, host data transfer or reorganization, etc. Video manager 116 may include applications, services, libraries, and/or corresponding interfaces for managing the video data contents of storage devices 120 on behalf of host device 102. For example, video manager 116 may include a video capture interface 116.1 configured to receive video data from video camera 108.1 through camera interface 108 as it is captured in real-time and converted to a video data format. Video manager 116 may include a video index 116.2 configured to identify video data objects received from video camera 108.1 and stored to storage devices 120 and organize corresponding metadata describing the video data objects or files. Video manger 116 may also include an event detector 116.3 configured to analyze video data to determine occurrences of one or more video events, such as objects of interest detected within the video frames. The various features and functions of video manager 116 may be used to support data routing controller 118 for directing incoming video data to intermediate storage and selectively migrating video data based on storage device TBW values.

Host device 102 may include a data routing controller 118 configured to receive video data from video manager 116 and direct it to storage locations in data storage devices 120.1 and 120.2. For example, data routing controller 118 may receive one or more real-time video data streams captured by video camera 108.1 and video capture interface 116.1 on a known video format. Device TBW manager 118.1 may receive and maintain TBW values for storage devices 120, such as based on configuration and operating parameters maintained by storage manager 114, and use those values to select one of the storage devices as intermediate storage for the video data stream. For example, data storage device 120.1 may be selected as intermediate storage based on the higher TBW rating of SLC devices 140.1-140.n, so long as the actual use of that device (operating TBW value) remains below a certain threshold. Data storage device 120.2 may be selected as primary storage based on a higher capacity but lower TBW rating of QLC devices 142.1-142.n. Intermediate logic 118.2 may include logic for selecting the storage locations and write commands/patterns for writing the incoming video data to the storage device selected for intermediate storage.

Data routing controller 118 may further include video transfer logic 118.3 for determining when video data should be moved from intermediate storage to primary storage. Video transfer logic 118.3 may monitor various factors related to the value and predicted invalidation of video data to determine whether and when video data should be moved from intermediate storage to primary storage or allowed to be invalidated and overwritten to provide space for additional incoming video data. Video transfer logic 118.3 may use video event classifier 118.4 to evaluate the contents of the video data to determine its value for longer term storage. For example, video event classifier 118.4 may use video metadata generated by event detector 116.3 and organized by video index 116.2 to determine video segments to be selectively transferred to prevent loss through invalidation when the retention cycle for the intermediate storage completes. Video transfer logic 118.3 may be configured to use retention policies 118.5 defined to manage the types and bounds of video segments that are selected for primary storage. In some configurations, retention policies 118.5 may be defined separately for intermediate storage and primary storage. Intermediate policy 118.5.1 may define the video event conditions for moving video segments to primary storage and the retention cycle that invalidates video data that has not been moved. Primary policy 118.5.2 may define video event conditions for retaining and deleting video segments in primary storage and may include conditions for offloading to remote storage, such as network storage system 190.

In some embodiments, network storage system 190 may be a cloud-based storage system supporting one or more data backup, recovery, and/or surveillance video management services. For example, storage server 170 may be a cloud server hosting an video data backup, management, and recovery application with a web, mobile application, or similar interface for storing surveillance video data in storage pool 180. In some embodiments, storage pool 180 may be a distributed data storage system configured with redundant data storage devices providing data availability and redundancy to storage server 170. For example, storage pool 180 may include geographically distributed rack storage system configured in RAID groups and clusters for supporting various server-based applications, including storage server 170. In some embodiments, storage server 170 may be configured to receive and store video data objects from storage devices 120 based on retention policies 118.5. In some embodiments, storage server 170 may include access control for receiving user credentials, such as username, password, and security certificates, for establishing secure image data transfer between data storage devices 120 and storage server 170 over network 160.

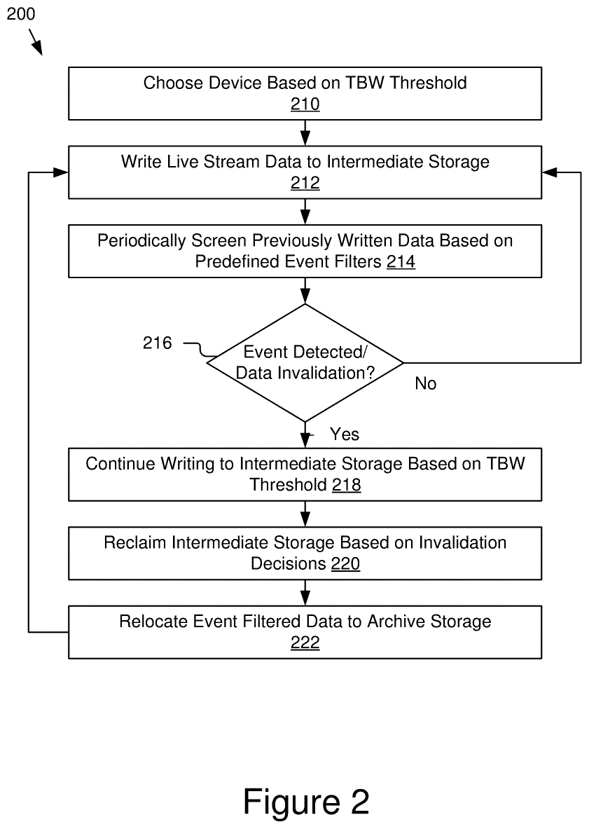

FIG. 2 illustrates a flowchart of method 200 for managing video data storage based on TBW values. Method 200 may be executed by a system comprising a processor, memory, and video and storage interfaces, which together facilitate the management and routing of video data to appropriate storage locations. The method may effectively orchestrate the storage of video data by comparing TBW values of different storage devices to determine the target storage location for intermediate and primary storage. The outcome of method 200 may be improved lifecycle management of storage devices used for video surveillance data, ensuring that video data units are stored in a manner that improve the endurance and efficiency of the storage devices.

At block 210, a device may be chosen based on a TBW threshold. For example, the storage system may select a storage device that has a TBW rating that exceeds a predefined threshold value as intermediate storage. In some configurations, a dashboard or surveillance camera may start streaming live video data captured by the video camera and the host device will choose an appropriate storage device based on the TBW threshold, such as an SLC device, to be intermediate storage and another storage device that does not meet the TBW threshold to be the primary, main partition, or archive storage device. In configurations with multiple storage devices meeting the TBW threshold, the host device may select the device with a higher TBW value first and track the operating TBW values to determine when to switch intermediate devices (such as when the remaining TBW of the first device drops below the remaining TBW of the second device).

At block 212, live stream data may be written to intermediate storage. For example, the storage system may temporarily store incoming video data in an intermediate storage location while it awaits further processing. The host device may store the live stream into the intermediate storage device and may use storage space reclaimed through invalidation or movement of data at blocks 220 and 222 (e.g., data blocks marked with an invalid flag and subject to garbage collection).

At block 214, previously written data may be periodically screened based on predefined event filters. For example, the storage system may periodically review stored video data to identify and flag video events of interest according to established criteria. The host device may screen the live streamed video data as it is received or through post-processing from intermediate storage based on a configured period or interval against one or more preconfigured events, such as objects detected with certain characteristics or confidence thresholds. These detected events may be marked in video metadata as key points or triggers that indicate different classes of useful data that may be considered for longer term or archival storage. In some configurations, video data not marked with some sort of detected event may automatically be marked for invalidation and erasure.

At decision block 216, it may be determined whether an event has been detected or if data invalidation is necessary. For example, the storage system may evaluate whether the video data contains an event that triggers a transfer of data to a different storage location or if the data is due for invalidation based on retention policies. If no qualifying event is detected and data in intermediate storage does not yet need to be invalidated for reuse in storing incoming live stream data, method 200 may return to block 212 to continue storing live stream data. If event filters are met and/or data in intermediate storage is due for invalidation, method 200 may proceed to block 218. The storage controller may be configured to not erase video data until that video data is screened for events, storage capacity in intermediate storage needs to be recycled, and the retention policy and corresponding event thresholds are evaluated for the data (e.g., marked invalid after transfer, no events found, or events of low value).

At block 218, the method may continue writing to intermediate storage based on the TBW threshold. For example, the storage system may continue to use the intermediate storage for new video data while determining whether existing data is moved or just invalidated to make room for the incoming data. In some configurations, blocks 216-222 may be triggered when the capacity used in the intermediate storage device or devices reaches a configurable capacity threshold, such as 60% used. At that point, blocks 220 and block 222 may be used to reclaim capacity for the incoming stream of video data.

At block 220, intermediate storage is reclaimed based on invalidation decisions. For example, the storage system may erase or mark data in the intermediate storage as invalid when it is determined that the data has not met event thresholds or has been transferred.

At block 222, event-filtered data is relocated to archive storage. For example, the storage system may move video data that has been flagged as containing events of interest to a primary storage device, selected based on TBW values, for future access and analysis. In some configurations, operation of method 200 may return to block 212 when the storage used in intermediate storage drops below the capacity threshold, such as due to relocation and/or invalidation of video data at blocks 220 and 222.

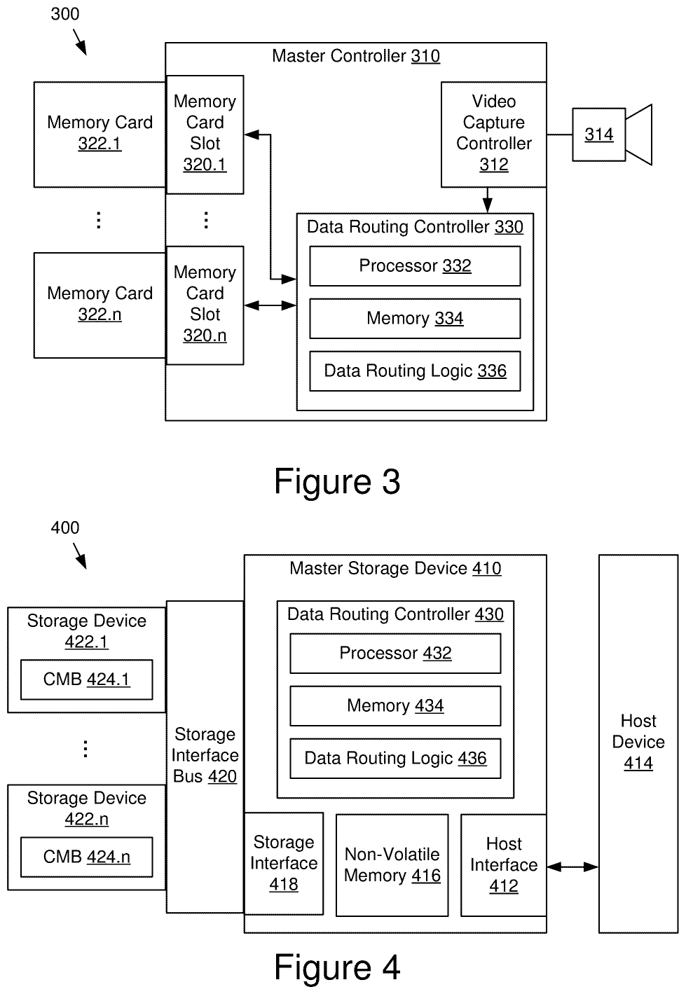

FIG. 3 presents a block diagram of a camera storage system 300, which outlines its system architecture. Camera storage system 300 may include a master controller 310, a video capture controller 312, a camera 314, memory card slots 320.1 to 320.n, memory cards 322.1 to 322.n, and a data routing controller 330. The system may be designed to manage the capture, storage, and routing of video data from the camera 314 to the appropriate memory cards 322.1 to 322.n for improved memory card endurance based on TBW values.

Master controller 310 may act as the video data manager for camera storage system 300, orchestrating the overall data flow and processing within the system. In some configurations, master controller 310 may be a bridge device, such as a bridge circuit board or package that is configured between video camera 314 and a set of storage devices. Master controller 310 may include or interface with video capture controller 312, which is responsible for the initial acquisition of video data from camera 314. Camera 314 may by the primary source of video input, capturing live footage that is to be processed and stored by the system. Camera 314 may include a video image sensor and logic for converting received video images into a time-based video stream of video data frames using a defined video data format.

Memory card slots 320.1 to 320.n may provide the physical interfaces for the insertion and connection of memory cards 322.1 to 322.n. These slots may allow for the modular addition and removal of storage capacity, accommodating a range of memory card sizes and types. Any number of two or greater memory card slots may be included to support a desired capacity and number of storage devices with different TBW ratings. Memory cards 322.1 to 322.n themselves may provide the non-volatile storage medium on which the video data is recorded and stored. They may vary in terms of storage capacity, data transfer speeds, and TBW ratings, offering flexibility to meet different storage requirements.

Data routing controller 330 may be tasked with directing the flow of video data within camera storage system 300. It may include a processor 332 and memory 334, which work together to execute the data routing logic 336. This logic may determine the specific path that video data takes from the camera 314 to the designated memory card 322.1 to 322.n. In some configurations, data routing controller 330 may be configured to determine and manage TBW values, designate intermediate and secondary storage among memory cards 322.1-322.n, and evaluate data retention policies for retention cycles, event thresholds, and video data movement and invalidation. For example, data routing controller 330 may be configured to execute method 200 in FIG. 2. In some configurations, master controller 310 may include and/or interface with an object detector or other video analysis engine for providing event metadata related to the content of the video data. For example, video camera 314 and/or another host system in communication with master controller 310 may include a video analysis subsystem that includes an object detector. In some configurations, data routing controller 330 may be configured as at least one hardware controller configured to operate alone or in combination to execute the functions of data routing logic 336. For example, an ASIC may be configured with specialized circuitry that distributes the processing, memory, and interfaces among logic circuits and memory registers for executing the functions of data routing logic 336. In some configurations, multiple hardware controllers may contribute to the functions of data routing controller 330.

FIG. 4 presents a block diagram of storage system 400, which outlines its system architecture. Storage system 400 may include a master storage device 410 in communication with a host device 414 and a storage interface bus 420 connecting multiple storage devices 422.1 to 422.n. Storage system 400 may enable master storage device 410 to control data storage to any number of other storage devices offering a variety of capacity and TBW configurations for video data storage. The system is designed for master storage device 410 to manage data distribution and storage across multiple other storage devices for improved endurance based on TBW values.

Master storage device 410 may serve as the primary storage controller for the storage system 400, managing the distribution and storage of data among the connected storage devices. Host interface 412 may facilitate communication between the master storage device 410 and host device 414, allowing for data transfer and system control commands to be exchanged. For example, host interface 412 may include a PCIe, network, or USB interface to host device 414 and support a storage protocol for sending a video data stream to master storage device 410. In some configurations, master storage device 410 may be a conventional data storage device, such as an SSD or memory card, and include a device controller configured to manage host interface 412 and non-volatile memory 416 for storage operations that store video data within master storage device 410. For example, master storage device 410 may be selected as a high TBW device and use no-volatile memory 416 as a candidate for intermediate storage. In some configurations, non-volatile memory 416 may be SLC flash memory.

Storage interface 418 may act as a gateway for data flow between master storage device 410 and slave storage devices 422.1 to 422.n via the storage interface bus 420. Storage interface bus 420 provides the physical and logical connections between the master storage device 410 and each of the storage devices 422.1 to 422.n, enabling coordinated data storage and retrieval operations. In some configurations, storage interface 418 may be a PCIe interface supporting NVMe storage protocols for communication among master storage device 410 and storage devices 422.1-422.n. The storage devices may be configured for direct memory access, such as using remote direct memory access (RDMA) protocols, and each storage device may include a controller memory buffer (CMB) configured for host data transfer. Master storage device 410 may be configured as a host or initiator device with respect to storage devices 422.1-422.n to enable master storage device 410 to use direct memory access to CMBs 424.1-424.n for transferring video data to or among storage devices 422.1-422.n. Storage devices 422.1 to 422.n each have their own TBW rating, which can be utilized by the master storage device 410 to improve device endurance through proactive management of intermediate and primary storage based on TBW values.

Data routing controller 430 may be tasked with directing the flow of video data within storage system 300. It may include a processor 432 and memory 434, which work together to execute data routing logic 436. In some configurations, data routing controller 430 may be embodied in hardware and/or firmware within the device controller of master storage device 410 and processor 432 and memory 434 may include the compute resources of the device controller. For example, data routing logic 436 may be embodied in firmware running on the storage manager of the device controller using the storage device's operating processor and memory. Data routing logic 436 may determine the specific path that video data takes from host device 414 to the designated storage locations in the storage devices, including master storage device 410 and storage devices 422.1 to 422.n. In some configurations, data routing controller 430 may be configured to determine and manage TBW values, designate intermediate and secondary storage, and evaluate data retention policies for retention cycles, event thresholds, and video data movement and invalidation. For example, data routing controller 430 may be configured to execute method 200 in FIG. 2. In some configurations, master controller 410 may include and/or interface with an object detector or other video analysis engine for providing event metadata related to the content of the video data. For example, host device 414 may include a video analysis subsystem that includes an object detector.

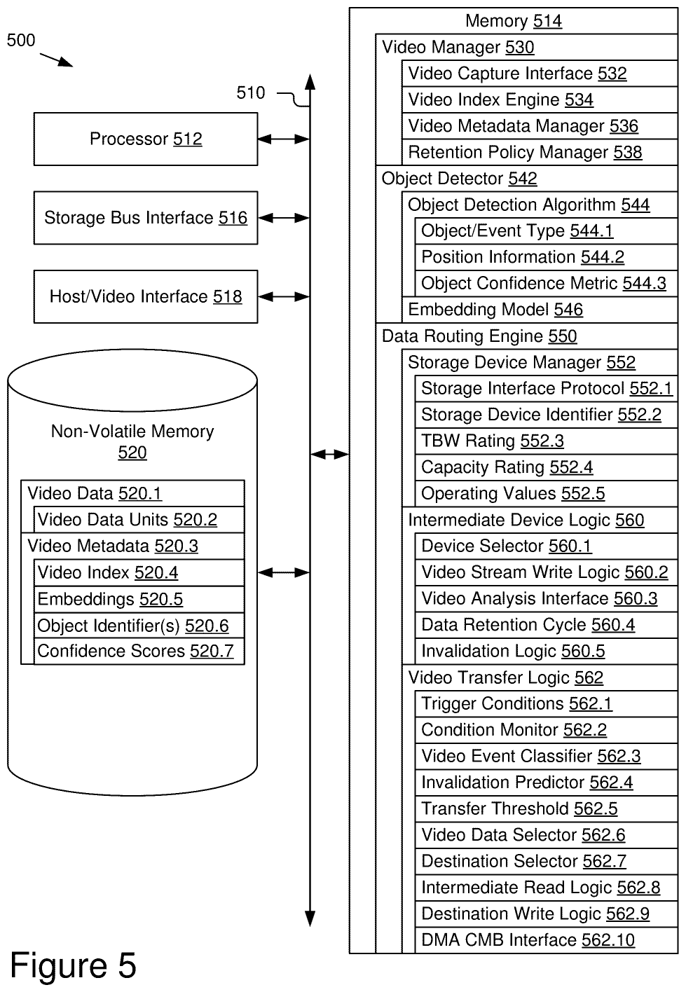

FIGS. 5 schematically shows selected modules of a camera storage system 500 configured for using lifetime endurance values, such as TBW ratings and operating values, to select among multiple data storage devices having different lifetime endurance ratings and values and route video data among them based on various video events and retention policies. Storage system 500 may incorporate elements, methods, and configurations similar to those shown in FIGS. 1-4. For example, storage system 500 may include a host system, master controller bridge, and/or master storage device configured with a data routing controller that embodies some or all functions of data routing engine 550. The functions of video manager 530 and object detector 542 may be embodied in a host device or video camera for use receiving and managing the metadata and storage information for the video data and determining video events from that video data.

Storage system 500 may include a bus 510 interconnecting at least one processor 512, at least one memory 514, and at least one interface, such as storage bus interface 516 and host/video interface 518. Bus 510 may include one or more conductors that permit communication among the components of storage system 500. Processor 512 may include any type and number of processors or microprocessors that interpret and execute instructions or operations. Processor 512 may include multiple processors or processor cores that operate alone or in combination to execute various threaded or distributed compute operations to carry out the functions described. Memory 514 may include a random access memory (RAM) or another type of dynamic storage device that stores information and instructions for execution by processor 512 and/or a read only memory (ROM) or another type of static storage device that stores static information and instructions for use by processor 512 and/or any suitable storage element such as a hard disk or a solid state storage element.

Storage bus interface 516 may be configured to use bus and/or network communication protocols to establish data storage connections with a number of data storage devices. Host connectors and device connectors supporting storage bus interface 110 may include any type of physical connector compatible with one or more bus, network, and/or internet protocols. For example, storage bus interface 516 may include ethernet, PCIe, Fibre Channel, SCSI, SAS, or another data storage interface. Storage bus interface 516 may include or interconnect with a plurality of physical port connections and intermediate components that define physical, transport, and other logical channels for establishing communication with the different storage devices for establishing a communication channel within storage system 500, such as between a host device and several storage devices. In some embodiments, storage bus interface 516 may include data storage connections to storage devices with different TBW values for selective use as intermediate and primary storage.

Host/video interface 518 may be configured to use bus and/or network communication protocols to establish at least one video data connection with a video camera, video image sensor, and/or host device including a video camera or receiving video data from a video camera. Host/video interface 518 may include any internal or external data interface configured to transmit captured video data to video manager 530, object detector 542, and/or data routing engine 550. For example, host/video interface 516 may include ethernet, PCIe, Fibre Channel, SCSI, SAS, or another data transfer interface.

Camera storage system 500 may include one or more non-volatile memory devices 520 configured to store video data 520.1. For example, non-volatile memory devices 520 may include a plurality of flash memory packages organized as an addressable memory array and/or any data storage device, such as data storage devices 120 in FIG. 1, memory cards 322.1-322.n in FIG. 3, or storage devices 422.1-422.n in FIG. 4. In some embodiments, non-volatile memory devices 520 may include NAND or NOR flash memory devices comprised of single level cells (SLC), multiple level cell (MLC), triple-level cells (TLC), quad-level cells (QLC), penta-level cells (PLC), etc. These different flash memory types may have different lifetime endurance values, such as TBW ratings, and different memory devices may have different operating lifetime endurance values that track the volume of data written to the memory device to estimate the current lifetime endurance capacity used. In some configurations, different types of non-volatile memory devices may be included in different data storage devices or within one data storage device (e.g., hybrid SSDs with both SLC and higher level cell memory devices).

Non-volatile memory 520 may store video data 520.1 in video data units, such as video data files or objects, that may include video data frames encoded according to a video format that defines frame rate, resolution, frame size, compression, etc. Video data units may include or be associated with video metadata 520.3 for storing video parameters related to format, source, and time of video capture. In some configurations, video metadata 520.3 may include a video index 520.4 to organize video data from one or more video cameras, one or more data capture sessions, and/or timestamps within the video data stream (and resulting video data units). Video metadata 520.3 may be configured to store metadata related to object detector 542, such as embeddings 520.5 (e.g., feature vectors abstracted from video frame data), object identifiers 520.6 (e.g., object types, locations, timestamps, and other characteristics or parameters determined by object detectors and related classifiers), and/or confidence scores 520.7 (e.g., confidence parameters generated by machine learning models used by object detector 542 that represent a likelihood that the object has been correcting detected/classified). In some configurations, video metadata 520.3 may be organized in a metadata data structure, such as a metadata table maintained separately from the video data units, and/or be embedded in a metadata portion or metadata track associated with the particular video data format. In some configurations, video data 520.1 may include audio data stored in one or more audio tracks in addition to the video frame (image) data.

Camera storage system 500 may include a plurality of modules or subsystems that are stored and/or instantiated in memory 514 for execution by processor 512 as instructions or operations. For example, memory 514 may include a video manager 530 configured to receive, index, organize, and enable user interaction with video data 520.1 stored in non-volatile memory 520 and associated video retention policies. Memory 514 may include an object detector 542 configured to detect and classify one or more predetermined object types in video data 520.1. Memory 514 may include a data routing engine 550 configured to select among storage devices for non-volatile memory 520, manage intermediate storage of video data 520.1, and control the transfer and/or invalidation/reuse of video data 520.1 over time.

Video manager 530 may include interface protocols, functions, parameters, and/or data structures for receiving and organizing video data units 520.2 and related video metadata 520.3 to enable system and user management, display, navigation, and other uses of video data units 520.2. For example, video manager 530 may include an application or service of a host device or video camera that storage system 500 uses to receive, organize, and display videos stored storage system 500 to support one or more surveillance interfaces on the host system, video camera, or another end user device (such as a surveillance monitoring application on a mobile device or remote computer system). In some embodiments, video manager 530 may include a plurality of hardware and/or software modules configured to use processor 512 and memory 514 to handle or manage defined operations of image manager 530. For example, image manager 530 may include a video capture interface 532 configured to receive video data 520.1 as a live stream from video camera. Video manager 530 may include a video indexing engine 534 configured to organize video data units 520.2 and identify their storage locations and various system or object metadata for each video data unit 520.2. Video manager 530 may include a video metadata manager 536 configured to store video metadata 520.3 in one or more data structures in non-volatile memory 520, such as video metadata tables and/or metadata tags/tracks associated with individual video data units 520.2 and/or storage locations. Image manager 530 may include a retention policy manager 538 configured to store configuration parameters for managing retention and transfer policies for video data 520.1 and may provide a user interface for selectively configuring those policies.

Video capture interface 532 in may be configured to receive video data 520.1 as a live stream from a video camera, serving as the initial point of entry for video content into the storage system 500. This interface may use host/video interface 516 to receive video data. In some configurations, video capture interface 532 may include hardware components such as video digitizers or frame grabbers that are compatible with various video camera outputs, including high-definition media interface (HDMI), standard definition interface (SDI), or composite connections. Host/video interface 518 may include compatible inputs for those connections. Video capture interface 532 may utilize drivers and video processing libraries that support real-time video data acquisition and format conversion, ensuring compatibility with different video camera technologies. Additionally, video capture interface 532 may offer features such as automatic video signal detection and format adjustment, facilitating seamless integration with a wide range of video camera models and specifications. In some configurations, the video camera may be integrated with storage system 500 such that internal bus hardware and protocols are used by host/video interface 518 and video capture interface 532 to capture video data from the image sensor of the video camera.

Video indexing engine 534 may operate in conjunction with video capture interface 532 and data routing engine 550 to determine all video data units 520.2 stored in non-volatile memory 520. For example, indexing engine 534 may construct an index of files stored in non-volatile memory 520 to assist in retrieval and use of files by other applications. Indexing engine 534 may receive notification of video streams and destination video data units when received by video capture interface 532 and routed to storage locations by data routing engine 550. Indexing engine 534 may generate and/or add video data entries or records to video metadata 520.3 to generate video index 520.4. Indexing engine 534 may include storage location, video file type and related information, in video index 520.4. In some configurations, a video data stream may be captured as a time-based series of video data units of a predefined time interval and/or video capture interval determined by one or more video capture start and end triggers. Video index engine 534 may index video data units corresponding to video capture sessions and/or time-based sub-units of those sessions (e.g., a separate data unit for each 5 minutes of video captured).

Video metadata manager 536 may use video index 520.4 to store other metadata in video data entries corresponding to one or more video events detected in that video data. Video metadata manager 536 may be configured to manage basic system and file metadata associated with each video file and supplement it with metadata generated by other functions or modules, such as object detector 542. In some configurations, video metadata manager 536 may receive notification of video events detected by object detector 542 and generate metadata entries in a video metadata table, such as video index 520.4, including the parameters of those video events, including video frame and/or timestamp parameters for locating those events within the video data units. In some configurations, video metadata manager 536 may be configured to insert metadata tags or similar metadata structures into a metadata field or track of video data units 520.2. In some configurations, video metadata manager 536 may operate in conjunction with video index engine 534 and data routing engine 550 to reconfigure video data units 520.2 into smaller data units based on video event metadata in order to more efficiently isolate and transfer higher value video data including objects of interest from intermediate storage to primary storage.

Retention policy manager 538 may be configured to store configuration parameters for managing retention and transfer policies for video data 520.1. In some configurations, it may provide a user interface that allows users to selectively configure these policies, tailoring data management to specific requirements or preferences. In some configurations, retention policy manager 538 may include a software interface that interacts with configuration pages, database system, or other data structure to record data retention rules, such as retention cycles for intermediate storage, data expiration dates, or archival/transfer conditions for moving video data to primary storage. Retention policy manager 538 may store parameters describing the retention policies for intermediate storage, primary storage, and/or archival system offload for use by data routing engine 550 in directing live stream video data and subsequent selective transfers of analyzed video data based on detected video events. In some configurations, storage system 500 may include or connect to a graphical user interface that enables a user to select one or more configurable retention policy parameters for use in storage system 500 and retention policy manage 538 may receive and store those parameters.

Object detector 542 may include interface protocols, functions, parameters, and/or data structures configured to detect the presence of one or more objects of a predefined object type in an image. For example, object detector 542 may be configured and trained for a particular object type, such as cars, license plates, packages, animals, human faces, etc. Object detector 542 may read video data from intermediate storage to analyze that video data for objects and events of interest. Object detector 542 may be based on an object detection algorithm 544 selected from machine learning-based object detection algorithms and trained with an appropriate training data set for the type of object being detected. For example, a number of human face object detectors are available and may be pre-trained based on large, verified data sets. Camera storage system 500 may be configured with one or more object detectors associated with different object types. For example, one object detection algorithm 544 may be selected for a human face object type 544.1 and another object detection algorithm 544 may be selected for a dog object type 544.1. Each object detection algorithm 544 may include a corresponding object type 544.1 and return position information 544.2 and an object confidence metric 544.3 for each instance of the object detected in the image. For example, object detector 542 may use a single pass or double pass method and a trained neural network model to detect any number of objects of object type 544.1 and return a bounding box (or corresponding coordinates) for the object location of each object detected. In some embodiments, position information 544.2 may include position information values, such as the coordinates for a bounding box, in an output array or similar data structure for a plurality of detected objects. For example, object boundary data, such as two horizontal positions and two vertical positions to define a boundary box within the image frame, may be returned with a delimiter between each detected object. If multiple object detectors are operating, position information 544.2 for each object instance of each object type may be determined and corresponding position values returned. In some embodiments, each object detector may return a tag or key-word representing object type 544.1 appended to position information 544.2. Object detector 542 may also return object confidence metric 544.3 for each object detected and corresponding set of position information 544.2 returned. For example, object detector 542 may return an object detected confidence value between 0 and 1 (0-100%), corresponding to a percentage of certainty generated by the machine learning model. The detection of an object of interest by object detector 542 in a video frame or series of video frames may generate a video event. Determination of a video event may be based on the object confidence metric meeting a minimum event threshold, such as 50%, which may be a user configurable parameter.

In some embodiments, object detector 542 may include an embedding model 546 configured to extract embedding values quantifying a plurality of features describing the detected object. For example, a human face may be represented by a plurality of feature vectors corresponding to various facial features and their relative sizes, positions, and relationships. In some embodiments, established object detectors may be trained using large, verified data sets that may define a widely used population-based embedding model for quantifying feature vectors according to established standards. This may support use of the resulting embeddings across multiple applications and platforms and embeddings 520.5 may be stored as metadata associated with a particular image and may be transferred with that image. Embedding model 546 may generate a set of embedding values quantifying feature vectors based on a general population standard. In some embodiments, object detector 542 may return the set of embeddings from embedding model 546 associated with each object detected and appended to object type 544.1, position information 544.2, and object confidence metric 544.3. In some configurations, object detector 542 may further include one or more group classifiers or recognition algorithms for determining additional parameters of the detected object, such as object color, character recognition of license plates, facial recognition, activity recognition, etc. and additional parameters associated with the detected object may be added as detected object metadata. These additional trained algorithms may operate on one or more embeddings from embedding model 546 to generate additional object parameters.

Data routing engine 550 may include interface protocols, functions, parameters, and data structures for directing video data received by video manager 530 to intermediate and primary storage in non-volatile memory 520 based on TBW values and events detected by object detector 542. For example, data routing engine 550 may be embodied in a bridge device, controller, or data storage device in storage system 500 to determine intermediate and primary storage among non-volatile memory devices with different TBW ratings, direct real-time video streams to storage locations in the intermediate storage, and then evaluate retention policies and video data to determine whether video data in intermediate storage is moved to primary storage or invalidated without being moved. In some embodiments, data routing engine 550 may include a plurality of hardware and/or software modules configured to use processor 512 and memory 514 to handle or manage defined operations of data routing engine 550. For example, data routing engine 550 may include a storage device manager 552 configured to determine the available data storage devices and their capacity and TBW ratings, then monitor changes in their available capacity and remaining TBW values for use by intermediate device logic 560 and video transfer logic 562. For example, data routing engine 550 may include intermediate device logic 560 configured to select among storage devices for storing live stream video data to intermediate storage and monitor the intermediate storage to determine when video data needs to be invalidated to free up capacity for incoming video data. For example, data routing engine 550 may include video transfer logic 562 configured to evaluate trigger conditions for moving video data from intermediate storage to primary storage based on video events in the video data.

Storage device manager 552 may be configured to identify and determine the characteristics of available data storage devices, such as their capacity and TBW ratings, which are integral for managing data storage within the system. It may include a storage interface protocol 552.1 that allows for communication with various types of storage devices, facilitating the retrieval of their parameters and configurations. For example, connected storage devices may support one or more administrative commands to collect device type and parameter information, as well as operating information, such as self-monitoring analysis and reporting technology (SMART) data. In some configurations, storage device manager 552 may utilize a storage device identifier 552.2 to uniquely recognize each storage device connected to the system. In some configurations, storage device parameters collected may include the TBW rating 552.3, which is a device characteristic based on the memory type that estimates the lifetime endurance or total block writes that a device is designed to handle, and capacity rating 552.4, which is the total storage capacity of the device available for host use. These parameters may define the write endurance and capacity of each storage device for managing their roles as intermediate or primary storage. Operating values 552.5 may track real-time operational metrics of the storage devices, including operating TBW values, such as a current TBW value or percentage of the TBW rating used value, and capacity values, such as current capacity used and/or available, providing data that can be used by intermediate device logic 560 and video transfer logic 562 to make informed decisions about data routing and storage management.

Intermediate device logic 560 may include hardware and/or software interfaces for managing the flow of live stream video data to designated intermediate storage devices. It may include a device selector 560.1, which can dynamically choose the appropriate storage device based on TBW and capacity values determined by storage device manager 552. For example, device selector 560.1 may compare the TBW ratings of all connected storage devices or memory devices therein to determine TBW ratings over a TBW rating threshold to determine an initial set of intermediate storage candidates, then use current TBW and capacity values to load balance across the devices meeting the TBW rating threshold. Video stream write logic 560.2 may handle the actual process of writing incoming video data to the selected intermediate storage, ensuring efficient data handling. For example, video stream write logic 560.2 may manage a write buffer to receive live stream video data for video manager 530 and generate the host write commands to write video data units from the write buffer to the selected data storage device and storage locations. Video stream write logic 560.2 may also report write operations/volumes to storage device manager 552 for monitoring operating TBW and capacity values.

Once video data is written to the intermediate devices, intermediate device logic 560 may further manage or interface with object detector 542 for the analysis of the video data and enforce the data retention and invalidation of video data in intermediate storage. In some configurations, video analysis interface 560.3 may provide additional functionality for selecting video data in intermediate storage for analysis by object detector 542. For example, video analysis interface 560.3 may notify object detector 542 as new video data is received for analysis and monitor progress of object detector 542 to ensure that video data is analyzed prior to being invalidated and to support transfer decisions by video transfer logic 562. Data retention cycle 560.4 may be responsible for tracking the lifecycle of video data stored in intermediate storage, determining when data needs to be invalidated in order to free up intermediate storage capacity for incoming data. For example, data retention cycle 560.4 may be determined by calculating the capacity of the available memory devices meeting the TBW rating threshold and the video capture rate (actual or estimated) of the video capture operations, then selecting a retention threshold, such as 60% of capacity, to determine how often storage capacity will need to be recycled. An intermediate storage data retention cycle value may be a calculated, predefined, or configured time value, such as every 36 operating hours of the surveillance system. Invalidation logic 560.5 may then execute the process of marking outdated video data as invalid, freeing up storage capacity for new incoming video data. In some configurations, invalidation logic 560.3 may verify that video data has been analyzed by object detector 542 and evaluated by video transfer logic 562 prior to marking the video data unit and corresponding storage locations as invalid. For example, object detector 542 and/or video transfer logic 562 may set flags or similar parameters in video metadata 520.3 to indicate whether they have carried out their respective functions on video data units 520.2. In some configuration, video data marked as invalid may be treated as deleted and/or subject to the garbage collection routines of the respective data storage devices in their ordinary operations to free up capacity for reuse by intermediate device logic 560.

Video transfer logic 562 may include hardware and/or software components designed to orchestrate the movement of video data from intermediate storage to primary storage based on specific video events detected within the video data. It may include trigger conditions 562.1, which can be configured to determine when video transfer logic 562 operates on video data in intermediate storage. For example, trigger conditions 562.1 may include reaching a data retention cycle for intermediate storage and/or notification of an object detection event in video data in intermediate storage. Video transfer logic 562 may also include a condition monitor 562.2 that continuously evaluates the set trigger conditions to determine when transfer analysis is appropriate.

In some configurations, video event classifier 562.3 may analyze the video metadata and, more specifically, video object metadata generated by object detection events, to categorize video events and assist in decision-making for data transfers. For example, object detector 542 may be configured to detected multiple event types and/or determine related classifications or recognition, all of which may include corresponding confidence values. Video event classifier 562.3 may include logical rules for evaluating those parameters to determine specific object types, characteristics, and confidence thresholds for objects of interest that may be subject to transfer to primary storage (rather then loss to invalidation). Video event classifier 562.3 may operate on video metadata to classify video data units and time-based segments of video data therein in response to analysis by object detector 542. In some configurations, video event classifier 562.3 may operate as soon as objects are detected and notification of the detected video event is received by video transfer logic 562. In other configurations, video event classifier 562.3 may not operate on data stored in intermediate storage until transfer analysis is necessitated by approaching invalidation of that video data. An invalidation predictor 562.4 may forecast the potential for video data invalidation based on data retention cycle 560.4 and the video event classification. For example, storage device manager 552 and/or intermediate device logic 560 may provide operating capacity values reflecting the current available capacity of intermediate storage devices and a rate if incoming video data that enables invalidation predictor 562.4 to predict when a given video data unit is likely to be a candidate for invalidation and ensure that the data unit is evaluated for transfer ahead of that predicted invalidation window. The predicted timing window of the potential invalidation may then be combined with the video event class to determine an invalidation prediction value that corresponds to the likelihood that the video data does not include video events that would qualify for transfer to primary storage.

Once a video data unit from intermediate storage is selected for transfer evaluation, video event classifications and related parameters from video event classifier 562.3 may be compared against one or more transfer thresholds 562.5 that establishes criteria for when video data is transferred. For example, transfer thresholds 562.5 may include confidence thresholds for each type of object of interest and/or related parameters that should be met to identify video data to be retained. In some configurations, one or more transfer thresholds may be predefined or configured for each video event and object of interest that should be transferred in a corresponding retention policy for primary storage. Video data selector 562.6 may pinpoint the exact segments of video data for transfer. For example, to preserve storage space, an entire video data unit, such as a 5 minute video segment, does not need to be transferred if the detected object is only visible for a 30 second window. Video data selector 562.6 may use timestamps related to the detected video events in the video metadata and a video editing library compatible with the video format to automatically extract a smaller portion of the video data unit that includes the video event of interest into a new video data unit for transfer to primary storage. Destination selector 562.7 identifies the target primary storage location from among the data storage devices with TBW values below the threshold for intermediate storage. Destination selector 562.7 may be configured to overwrite video data in primary storage based on the retention policies defined for primary storage. In some configurations, destination selector 562.1 may be configured to select archival storage locations to offload video data prior to overwriting in primary storage and/or users or administrators may be expected to manage primary storage capacity and delete or offload video data to maintain available capacity for use by destination selector 562.7. Intermediate read logic 562.8 and destination write logic 562.9 manage the reading of data from intermediate storage and the writing of data to the primary storage, respectively. For example, intermediate read logic 562.8 may generate a read command to the intermediate storage device for a target video data unit to be transferred and destination write logic 562.9 may generate a write command to the primary storage device and storage location. In some configurations, the storage devices may be configured for direct memory access and use direct memory access controller memory buffer interface 562.10 to facilitate efficient data transfers between storage devices. For example, a storage device that includes intermediate storage may be configured to use RDMA protocols to directly transfer video data units from the media device providing intermediate storage to the CMB of the storage device acting as primary storage for the video data unit. This may reduce the need to buffer the video data unit between read and write operations.

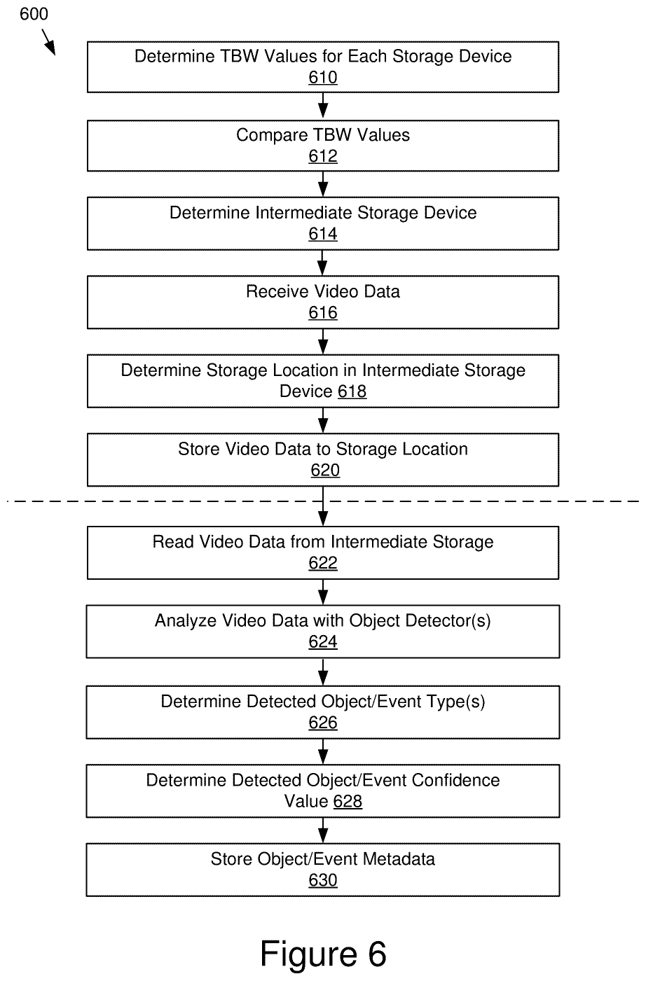

FIG. 6 presents a flowchart of method 600, which outlines a procedure for managing video data storage based on TBW values. This method may be implemented by a data storage system that includes at least one processor, memory, and various interfaces for video capture and storage device communication. The method aims to enhance the lifecycle management of storage devices by intelligently routing video data to storage locations based on their TBW values and detected video events. The outcome of method 600 is the strategic storage of video data in a way that increases the endurance and efficiency of the storage devices involved.

At block 610, TBW values may be determined for each storage device connected to the storage system. For example, the storage system may detect or receive data storage device type and/or configuration information that includes at least a TBW rating for each data storage device.

At block 612, TBW values for the different storage devices may be compared. For instance, the storage system may compare TBW ratings and/or operating values and compare them to each other and/or one or more TBW thresholds.

At block 614, intermediate storage devices may be determined. For example, one or more storage devices having TBW ratings and/or remaining TBW values meeting a threshold for intermediate storage may be selected.

At block 616, video data may be received. For example, the storage system may be integrated or interface with a video camera configured to generate real-time video data, such as a surveillance video data live stream.

At block 618, storage locations for the video data may be determined in storage device selected for intermediate storage. For example, the storage system may select unused storage locations in at least one storage device determined to be intermediate storage at block 614.

At block 620, the video data may be stored in the storage locations in intermediate storage. For example, the storage system may write the video data stream to the selected storage device as long as it remains the preferred option according to the TBW threshold criteria.

At block 622, the system may read the video data unit from the intermediate storage for analysis. This step may involve transferring the data from the storage location to an object detector configured to determine events of interest from the video data.

At block 624, the system may analyze the video data unit to determine whether it includes at least one video event of interest. This analysis may utilize object detector algorithms and other classifier/recognition software to identify specific events within the video data that are of particular relevance or require action.

At block 626, the system may determine the type of video event of interest within the video data unit. For example, the system may classify the video event based on parameters generated by the object detector or other processing into one or more categories of interest that may be subject to video data retention policies.

At block 628, the system may determine a confidence value for the video event of interest. For example, the object detector may generate a confidence value related to the object type detected, which may be used to assess the likelihood that the detected event is accurately classified or of sufficient quality to warrant transfer to primary storage.

At block 630, the system stores object/event metadata related to the video data unit. For example, the storage system may include a video index identifying each video data unit stored in intermediate storage and add object/event metadata that includes information such as the type of event, the confidence value, timestamps, and other relevant data that can be used for data retention and transfer decision-making purposes.

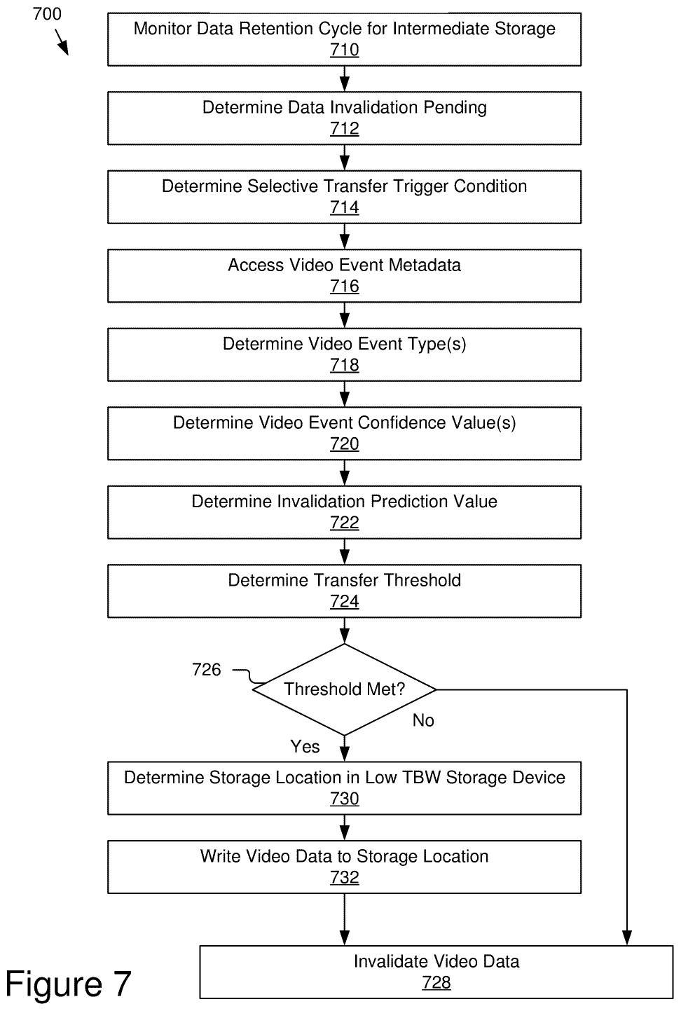

FIG. 7 depicts a flowchart of method 700, which outlines a procedure for managing video data storage based on TBW values. This method may be executed by a storage system that includes components such as a processor and memory and data storage device interfaces, which are responsible for executing the steps of the method. The method systematically evaluates video data to determine the appropriate timing and conditions for transferring data from intermediate storage to primary storage. The outcome of method 700 is the efficient relocation of video data units to a more permanent storage location based on video event classification.

At block 710, the data retention cycle for intermediate storage may be monitored. For example, the storage system may track the duration that video data has been stored in intermediate storage and how much storage is available to determine if it is due for transfer or invalidation.

At block 712, whether data invalidation is pending may be determined. The storage system may assess whether the video data in intermediate storage has reached a threshold or other trigger event that triggers a review for potential transfer or invalidation.

At block 714, a selective transfer trigger condition may be determined. The storage system may identify conditions under which a video data unit should be evaluated for transfer from intermediate storage to primary storage, such as pending invalidation and at least one video event detected in the video data unit.

At block 716, video event metadata may be accessed. For instance, the storage system may retrieve metadata associated with video data units to assist in the decision-making process for data transfer.

At block 718, the type of video event of interest in the video data unit may be determined. The storage system may support multiple video events, such as the detection of different object types or parameters associated with those object types, and retrieve the event type or object parameters for determining event type from the video metadata to understand its relevance and priority for transfer.

At block 720, a confidence value for the video event of interest may be determined. The storage system may retrieve at least one confidence value indicating the likelihood that the detected event is accurately detected, classified, or recognized.

At block 722, an invalidation prediction value is determined. The storage system may predict when video data is likely to become a candidate for invalidation based on current retention policies, video event types, confidence values and confidence thresholds, and/or other video metadata.

At block 724, a transfer threshold is determined. The storage system may establish criteria that video data units in intermediate storage would have to meet to be eligible for transfer to primary storage, generally based on the likelihood of invalidation of the video data because it does not contain video events of sufficient interest.

At decision block 726, whether the invalidation prediction value meets the transfer threshold may be determined. The storage system may compare the invalidation prediction value against the transfer threshold to decide if the video data unit is due for transfer. If the transfer threshold is not met, the video data is not of sufficient value to save and method 700 may proceed to block 728. If the transfer threshold is met, the video data should be retained for longer term storage, notifications, and/or further analysis and method 700 may proceed to block 730.

At block 728, the video data unit in the first storage location may be invalidated. The storage system may mark the video data unit as invalid, freeing up space in intermediate storage for new data.

At block 730, a storage location in a low TBW storage device may be determined for video data units. The storage system may select an appropriate location in primary storage with a lower TBW rating (and generally higher capacity) to store the transferred video data unit.

At block 732, the video data is written to the storage location in the low TBW storage device. The storage system may execute the transfer of the video data unit to the designated primary storage location, ensuring its preservation for future access and analysis.

While at least one exemplary embodiment has been presented in the foregoing detailed description of the technology, it should be appreciated that a vast number of variations may exist. It should also be appreciated that an exemplary embodiment or exemplary embodiments are examples, and are not intended to limit the scope, applicability, or configuration of the technology in any way. Rather, the foregoing detailed description will provide those skilled in the art with a convenient road map for implementing an exemplary embodiment of the technology, it being understood that various modifications may be made in a function and/or arrangement of elements described in an exemplary embodiment without departing from the scope of the technology, as set forth in the appended claims and their legal equivalents.

As will be appreciated by one of ordinary skill in the art, various aspects of the present technology may be embodied as a system, method, or computer program product. Accordingly, some aspects of the present technology may take the form of an entirely hardware embodiment, an entirely software embodiment (including firmware, resident software, micro-code, etc.), or a combination of hardware and software aspects that may all generally be referred to herein as a circuit, module, system, and/or network. Furthermore, various aspects of the present technology may take the form of a computer program product embodied in one or more computer-readable mediums including computer-readable program code embodied thereon.

Any combination of one or more computer-readable mediums may be utilized. A computer-readable medium may be a computer-readable signal medium or a physical computer-readable storage medium. A physical computer readable storage medium may be, for example, but not limited to, an electronic, magnetic, optical, crystal, polymer, electromagnetic, infrared, or semiconductor system, apparatus, or device, etc., or any suitable combination of the foregoing. Non-limiting examples of a physical computer-readable storage medium may include, but are not limited to, an electrical connection including one or more wires, a portable computer diskette, a hard disk, random access memory (RAM), read-only memory (ROM), an erasable programmable read-only memory (EPROM), an electrically erasable programmable read-only memory (EEPROM), a Flash memory, an optical fiber, a compact disk read-only memory (CD-ROM), an optical processor, a magnetic processor, etc., or any suitable combination of the foregoing. In the context of this document, a computer-readable storage medium may be any tangible medium that can contain or store a program or data for use by or in connection with an instruction execution system, apparatus, and/or device.

Computer code embodied on a computer-readable medium may be transmitted using any appropriate medium, including but not limited to, wireless, wired, optical fiber cable, radio frequency (RF), etc., or any suitable combination of the foregoing. Computer code for carrying out operations for aspects of the present technology may be written in any static language, such as the C programming language or other similar programming language. The computer code may execute entirely on a user's computing device, partly on a user's computing device, as a stand-alone software package, partly on a user's computing device and partly on a remote computing device, or entirely on the remote computing device or a server. In the latter scenario, a remote computing device may be connected to a user's computing device through any type of network, or communication system, including, but not limited to, a local area network (LAN) or a wide area network (WAN), Converged Network, or the connection may be made to an external computer (e.g., through the Internet using an Internet Service Provider).

Various aspects of the present technology may be described above with reference to flowchart illustrations and/or block diagrams of methods, apparatus, systems, and computer program products. It will be understood that each block of a flowchart illustration and/or a block diagram, and combinations of blocks in a flowchart illustration and/or block diagram, can be implemented by computer program instructions. These computer program instructions may be provided to a processing device (processor) of a general purpose computer, special purpose computer, or other programmable data processing apparatus to produce a machine, such that the instructions, which can execute via the processing device or other programmable data processing apparatus, create means for implementing the operations/acts specified in a flowchart and/or block(s) of a block diagram.

Some computer program instructions may also be stored in a computer-readable medium that can direct a computer, other programmable data processing apparatus, or other device(s) to operate in a particular manner, such that the instructions stored in a computer-readable medium to produce an article of manufacture including instructions that implement the operation/act specified in a flowchart and/or block(s) of a block diagram. Some computer program instructions may also be loaded onto a computing device, other programmable data processing apparatus, or other device(s) to cause a series of operational steps to be performed on the computing device, other programmable apparatus or other device(s) to produce a computer-implemented process such that the instructions executed by the computer or other programmable apparatus provide one or more processes for implementing the operation(s)/act(s) specified in a flowchart and/or block(s) of a block diagram.

A flowchart and/or block diagram in the above figures may illustrate an architecture, functionality, and/or operation of possible implementations of apparatus, systems, methods, and/or computer program products according to various aspects of the present technology. In this regard, a block in a flowchart or block diagram may represent a module, segment, or portion of code, which may comprise one or more executable instructions for implementing one or more specified logical functions. It should also be noted that, in some alternative aspects, some functions noted in a block may occur out of an order noted in the figures. For example, two blocks shown in succession may, in fact, be executed substantially concurrently, or blocks may at times be executed in a reverse order, depending upon the operations involved. It will also be noted that a block of a block diagram and/or flowchart illustration or a combination of blocks in a block diagram and/or flowchart illustration, can be implemented by special purpose hardware-based systems that may perform one or more specified operations or acts, or combinations of special purpose hardware and computer instructions.

While one or more aspects of the present technology have been illustrated and discussed in detail, one of ordinary skill in the art will appreciate that modifications and/or adaptations to the various aspects may be made without departing from the scope of the present technology, as set forth in the following claims.

1. A system comprising:
at least one processor;
at least one memory;
at least one storage device interface configured for communication with:
a first data storage device configured to store video data, wherein the first data storage device has a first lifetime endurance rating; and
a second data storage device configured to store video data, wherein the second data storage device has a second lifetime endurance rating;
a video capture interface configured to receive video data from a video sensor; and
at least one data routing controller configured to, alone or in combination:
receive a video data unit from the video capture interface;
determine a first lifetime endurance value for the first data storage device;
determine a second lifetime endurance value for the second data storage device;
determine, based on a comparison of the first lifetime endurance value and the second lifetime endurance value determining that the first data storage device has a greater lifetime endurance value, a first storage location in the first data storage device for the video data unit;
store the video data unit to the first storage location;
determine, for the video data unit, an invalidation prediction value, wherein the invalidation prediction value indicates a time at which the video data unit will be invalidated in the first data storage device;
determine, for the video data unit, a transfer threshold value, wherein the transfer threshold value is based on content of the video data unit;
selectively write, based on the invalidation prediction value and the transfer threshold value, the video data unit from the first storage location to a second storage location in the second data storage device; and
invalidate the video data unit in the first storage location.

2. The system of claim 1, wherein:
the first lifetime endurance rating is based on a first flash memory type;
the second lifetime endurance rating is based on a second flash memory type;
the first flash memory type and the second flash memory type are selected from:
NAND cells having one bit per cell;
NAND cells having two bits per cell;
NAND cells having three bits per cell;
NAND cells having four bits per cell; and
NAND cells having at least five bits per cell; and
the first flash memory type is different than the second flash memory type.

3. The system of claim 1, wherein:
the invalidation prediction value is based on a combination of at least two factors selected from:
a data retention policy for the first data storage device;
a fill rate and available capacity for the first data storage device;
a video event type associated with the video data unit; and
a confidence value for the video event type; and
the transfer threshold value is configured to, based on metadata related to the video data unit, select video data related to at least one video event of interest to preserve through transfer to the second data storage device determine, for the video data unit, an invalidation prediction value.

4. The system of claim 1, wherein:
the at least one data routing controller is further configured to:
monitor a data retention cycle for captured video data; and
determine, based on the data retention cycle, that the video data unit in the first storage location is due for invalidation; and
the invalidation prediction value is based on a fill rate of the first data storage device predicting the time that the data retention cycle will invalidate the video data unit in the first storage location.

5. The system of claim 4, wherein the data retention cycle is based on a configurable fill threshold of the first data storage device.

6. The system of claim 1, wherein the at least one processor is configured to:
analyze the video data unit to determine whether the video data unit includes at least one video event of interest, wherein the at least one data routing controller is further configured to determine the invalidation prediction value responsive to and based on the at least one video event of interest.

7. The system of claim 6, wherein:
the at least one processor is further configured to determine:
at least one video event type of the at least one video event of interest in the video data unit; and
at least one confidence value for the at least one video event of interest; and
the invalidation prediction value for the video data unit is based on:
the at least one video event type; and
the at least one confidence value for the at least one video event of interest meeting a confidence threshold.

8. The system of claim 6, wherein the at least one processor is further configured to read the video data unit from the first storage location to analyze the video data unit.

9. The system of claim 1, further comprising:
a video camera comprising:
the video sensor;
the at least one processor;
the at least one memory;
the at least one storage device interface, wherein the at least one storage device interface comprises at least two memory card slots configured to receive the first data storage device and the second data storage device;
the video capture interface; and
the at least one data routing controller.

10. The system of claim 1, further comprising:
the first data storage device, wherein:
the first data storage device comprises:
the at least one processor;
the at least one memory;
the at least one data routing controller; and
a host interface configured to receive the video data from a host system;
the at least one storage device interface comprises a storage interface bus connecting the first data storage device and the second data storage device; and
the first data storage device is configured as bridge device between the host system and a plurality of secondary data storage devices; and
the plurality of secondary data storage devices, wherein:
each data storage device of the plurality of secondary data storage devices:
comprises a controller memory buffer configured for direct memory access by the first data storage device; and
has a lifetime endurance rating that is different from the first lifetime endurance rating of the first data storage device; and
the plurality of secondary data storage devices includes the second data storage device.

11. A computer-implemented method, comprising:
receiving a video data unit generated by a video sensor;
determining a first lifetime endurance value for a first data storage device configured to store video data, wherein the first data storage device has a first lifetime endurance rating;
determining a second lifetime endurance value for a second data storage device configured to store video data, wherein the second data storage device has a second lifetime endurance rating;
determining, based on a comparison of the first lifetime endurance value and the second lifetime endurance value determining that the first data storage device has a greater lifetime endurance value, a first storage location in the first data storage device for the video data unit;
storing the video data unit to the first storage location;
determining, for the video data unit, an invalidation prediction value, wherein the invalidation prediction value indicates a time at which the video data unit will be invalidated in the first data storage device;
determining, for the video data unit, a transfer threshold value, wherein the transfer threshold value is based on content of the video data unit;
selectively writing, based on the invalidation prediction value and the transfer threshold value, the video data unit from the first storage location to a second storage location in the second data storage device; and
invalidating the video data unit in the first storage location.

12. The computer-implemented method of claim 11, wherein:
the first lifetime endurance rating is based on a first flash memory type;
the second lifetime endurance rating is based on a second flash memory type;
the first flash memory type and the second flash memory type are selected from:
NAND cells having one bit per cell;
NAND cells having two bits per cell;
NAND cells having three bits per cell;
NAND cells having four bits per cell; and
NAND cells having at least five bits per cell; and
the first flash memory type is different than the second flash memory type.

13. The computer-implemented method of claim 11, wherein:
the invalidation prediction value is based on a combination of at least two factors selected from:
a data retention policy for the first data storage device;
a fill rate and available capacity for the first data storage device;
a video event type associated with the video data unit; and
a confidence value for the video event type; and
the transfer threshold value is configured to, based on metadata related to the video data unit, select video data related to at least one video event of interest to preserve through transfer to the second data storage device.

14. The computer-implemented method of claim 11, further comprising:
monitoring a data retention cycle for captured video data; and
determining, based on the data retention cycle, that the video data unit in the first storage location is due for invalidation, wherein the invalidation prediction value is based on a fill rate of the first data storage device predicting the time that the data retention cycle will invalidate the video data unit in the first storage location.

15. The computer-implemented method of claim 14, wherein the data retention cycle is based on a configurable fill threshold of the first data storage device.

16. The computer-implemented method of claim 11, further comprising:
analyzing the video data unit to determine whether the video data unit includes at least one video event of interest; and
determining the invalidation prediction value responsive to and based on the at least one video event of interest.

17. The computer-implemented method of claim 16, further comprising:
determining at least one video event type of the at least one video event of interest in the video data unit; and
determining at least one confidence value for the at least one video event of interest, wherein the invalidation prediction value for the video data unit is based on:
the at least one video event type; and
the at least one confidence value for the at least one video event of interest meeting a confidence threshold.

18. The computer-implemented method of claim 16, further comprising:
reading the video data unit from the first storage location to analyze the video data unit.

19. The computer-implemented method of claim 11, further comprising:
receiving, by the first data storage device and from a host system, the video data unit;
storing, by the first data storage device, the video data unit to the first storage location;
selecting the second data storage device from a plurality of secondary data storage devices in communication with the first data storage device, wherein each data storage device of the plurality of secondary data storage devices has a lifetime endurance rating that is different from the first lifetime endurance rating of the first data storage device;
writing, using direct memory access, the video data unit to a controller memory buffer of the second data storage device; and
invalidating the video data unit in the first storage location.

20. A video camera, comprising:
a video sensor;
at least one processor;
at least one memory;
at least one storage device interface, wherein the at least one storage device interface comprises means to receive a first data storage device and a second data storage device, wherein:
the first data storage device is configured to store video data and has a first lifetime endurance rating; and
the second data storage device is configured to store video data and has a second lifetime endurance rating;
means for generating a video data unit from the video sensor;
means for determining a first lifetime endurance value for the first data storage device;
means for determining a second lifetime endurance value for the second data storage device;
means for determining, based on a comparison of the first lifetime endurance value and the second lifetime endurance value determining that the first data storage device has a greater lifetime endurance value, a first storage location in the first data storage device for the video data unit;
means for storing the video data unit to the first storage location;
means for determining, for the video data unit, an invalidation prediction value, wherein the invalidation prediction value indicates a time at which the video data unit will be invalidated in the first data storage device;
means for determining, for the video data unit, a transfer threshold value, wherein the transfer threshold value is based on content of the video data unit;
means for selectively writing, based on the invalidation prediction value and the transfer threshold value, the video data unit from the first storage location to a second storage location in the second data storage device; and
means for invalidating the video data unit in the first storage location.
